(19) United States
(12) Patent Application Publication
(10) Pub. No.: US 2004/0006922 A1
(43) Pub. Date: Jan. 15, 2004

(54) Gas assisted thermoplastic injected door

(76) Inventor: Peter Sibbett, Tacoma, WA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/600,398

(22) Filed: Jun. 20, 2003

Related U.S. Application Data
(60) Provisional application No. 60/390,342, filed on Jun. 20, 2002.

(51) Int. Cl. E06B 3/00

(52) U.S. Cl. 49/501; 264/572

(57) ABSTRACT

An assembled plastic door made of door skins and formed from a molten plastic resin by gas assisted thermoplastic injection molding.

### CROSS REFERENCE TO RELATED APPLICATIONS

This application claims the benefit of U.S. Provisional Application No. 60/390,342 filed Jun. 20, 2002 and incorporated in its entirety into the current application.

### BACKGROUND OF THE INVENTION

This invention relates to plastic articles and, in particular, to plastic doors formed by a gas assisted thermoplastic injection molding process. Further, the invention relates to a plastic door for holding an opaque or transparent sheet material, such as glass. In particular, the invention is directed to a gas assisted thermoplastic injection molded door and a method of making the door using gas assisted thermoplastic injection molding.

Traditionally, doors have been made of wood. The first doors were likely simple wood structures. As time went on, doors became more elaborate. The wooden doors were carved with elaborate scenes and decorations. Wood doors have “warmth” to them. Solid wooden doors are costly both in price and in materials. A solid wooden door requires more wood, a valuable and becoming difficult to replace, natural resource. Wood doors are limited by being difficult, time consuming, and expensive to manufacture along with being defect prone and heavy. Wood door manufacturing requires a long list of fabrication processes requiring days before the completed door is made.

For a variety of reasons, metal doors evolved from early wooden doors. In certain instances, metal doors can provide increased strength and safety. Also, metal doors do not warp, crack, and/or peel like traditional wood doors. Metal doors have better thermal performance than wood doors. However, metal doors may lack the aesthetic appeal of wooden doors, particularly carved wooden doors. Additional limitations of steel doors include that they can dent and rust.

The process for making metal (e.g., steel) doors is repetitive. Steel doors are stamped out of a sheet of metal. Therefore, they are cost effective to make. In an attempt to obtain both the wood door and steel door benefits, sheet molding compound (SMC) doors were developed. SMC doors are also referred to as fiberglass doors.

SMC doors do not rot and are not easily dented or cracked. They can also be manufactured with a mimetic wood texture. SMC doors are a move closer to the aesthetics of wood while still maintaining some of the advantages of steel. Yet, the SMC door making process is slow. Frequently, an assembled door is made from two skins held together in various manners (for example, adhesive). Sandwiched between the two skins may also be a layer of insulation or other material. Making one skin of an SMC door can take about 5 to 6 minutes. Therefore, making the two skins of the SMC door can take 10 to 12 minutes.

Another type of material used to make doors is particle board. Particle board is a structural material made of wood fragments, such as chips or shavings, which is mechanically pressed into sheet form and bonded together with resin. Particle board doors may have a core of wood particles and a laminated surface. While particle board doors may provide sound insulation, they may lack strength and aesthetic appeal. Because of this, particle board doors are often not used as exterior doors.

Another manner to make a door is by molding the door from a sheet of thermoset plastic or through injection molding. Using traditional molding processes for making plastic parts has, as at least one limitation, incomplete filling of the mold by the melted plastic. The length of the mold is sometimes so long that the plastic has cooled down before it can fill the entire length of the mold. Further, traditional molded doors have design limitations and are costly and time consuming to produce. Using traditional molding processes, a design compromise must often be made between strength and plastic thickness. A relatively thicker plastic section in the article, such as a structural rib, will incur additional weight, material usage, cycle time and induce sink marks and other surface defects due to thermal gradients in the area of the thickened section. Also, conventional injection molding frequently results in parts with sharp corners. Rounding the outside of a corner causes the piece to deflect to the inside whereas rounding of the inside of a corner can cause stress on the outside of the piece. There is a need in the art for a method of making a door which would eliminate the many steps required by traditional door manufacturing.

Typically, residential interior doors must be painted or stained in order for them to remain aesthetically pleasing. Many hollow core doors require adhesives and wood to hold together the two skins of the door. Further, exterior doors may also require foam inserted between the two door skins to insulate the doors.

These and other limitations and problems of the past are solved by the present invention.

### BRIEF SUMMARY OF THE INVENTION

A gas assisted thermoplastic injection molded door and a method of making a gas assisted thermoplastic injected molded door are shown and described.

A hollow plastic article of a one-piece construction being formed from a molten plastic resin by a gas assisted thermoplastic injection molding system is provided. The system includes a mold having an article-defining cavity and an injection aperture wherein the molten plastic resin is injected through the injection aperture and wherein at defined inlets pressurized gas is communicated to the molten plastic resin in the article-defining cavity to at least partially distribute the molten plastic resin. The article includes a hollow body section having a front wall, a rear wall, and interconnecting top and bottom walls formed by the pressurized gas to define a gas passageway or channel which extends at least partially through the hollow body section. The article also includes a solid wall section connected to the front wall and which extends downwardly from the front wall toward the rear wall immediately below the bottom wall of the hollow body section wherein the solid wall section and the front wall immediately adjacent the solid wall section define a convex, sink-free, exterior surface of the article to hide any gas channel read through.

An advantage of using gas assisted injected molding is reduced resin consumption by decreasing the product thickness. Another advantage is a shortened manufacturing cycle. Cooling time is decreased due to decreased thickness of the product.

Another advantage is improved product quality by preventing warpage due to decreased residual stress and the removal of sink marks.

Yet other advantages include: improved strength-to-weight ratio, balance, feel, and stress-free surfaces. It's also possible to create light parts with thick wall sections.

An additional advantage is that gas assisted injection molded doors eliminate the majority of steps in the traditional wood door manufacturing process.

Gas assisted thermoplastic injection molded doors exhibit the benefits of wood, steel, and SMC doors. The door assembly procedure for a gas assisted thermoplastic injection molded door will be faster than other conventional doors. Another advantage is that gas assisted thermoplastic injection molded doors can be molded already having a color imparted to them by coloring the melted plastic before it is poured into the mold. Additionally, since the floor size utilized by equipment for manufacturing a gas assisted injection molded door and a SMC door are comparable, because of the increased speed of manufacturing a gas assisted injection molded door, floor space and associated costs therewith are greatly reduced.

The invention will best be understood by reference to the following detailed description of the preferred embodiment, taken in conjunction with the accompanying drawings. The discussion below is descriptive, illustrative and exemplary and is not to be taken as limiting the scope defined by any appended claims.

### BRIEF DESCRIPTION OF SEVERAL VIEWS OF THE DRAWINGS

FIG. 1 shows a front view of one embodiment of a door formed by gas assisted thermoplastic injection molding.

FIG. 2 shows a side view of one embodiment of a door formed by gas assisted thermoplastic injection molding.

FIG. 3 shows a gas assisted thermoplastic injection mold.

FIG. 4 shows an article formed by gas assisted thermoplastic injection molding.

FIG. 5 shows injection of resin into a mold.

FIG. 6 shows injection of gas into a mold containing resin.

FIG. 7 shows gas held inside a mold.

FIG. 8 shows gas being vented from inside a mold.

FIG. 9 shows injection of resin into a door mold.

FIG. 10 shows gas injection into a door mold.

FIG. 11 shows one embodiment of complete injection of resin as gas injection continues into a door mold.

FIG. 12 shows resin completely filling the door mold.

FIG. 13 shows a cooled door within a mold.

### DETAILED DESCRIPTION OF THE INVENTION

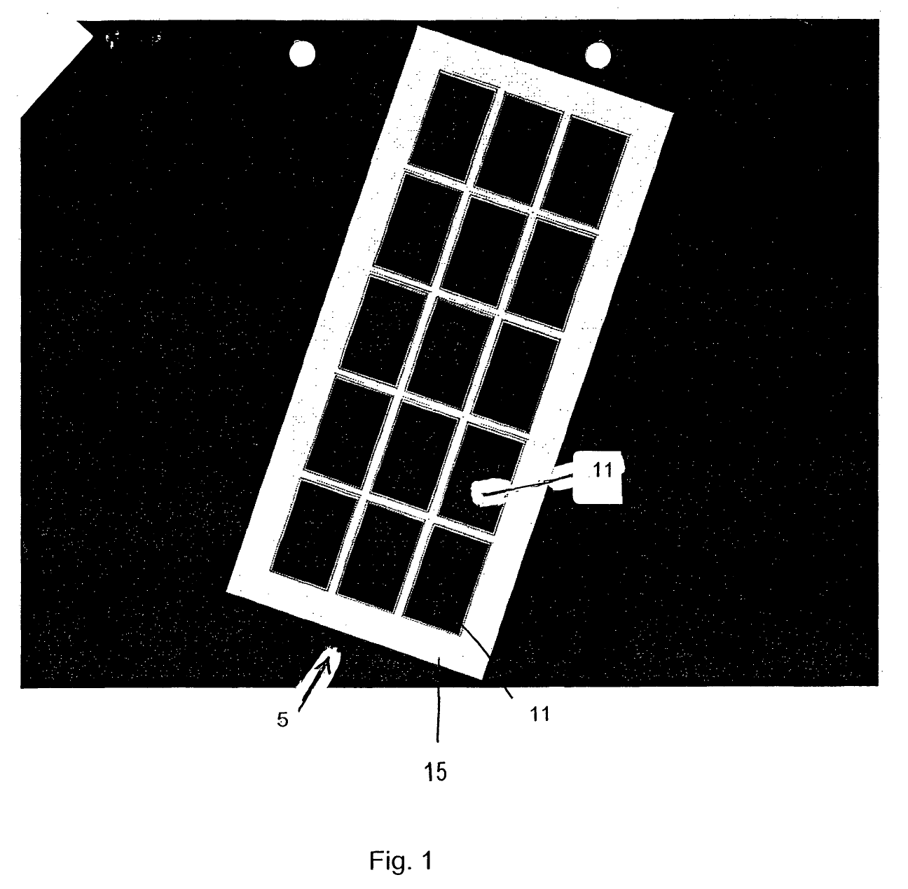

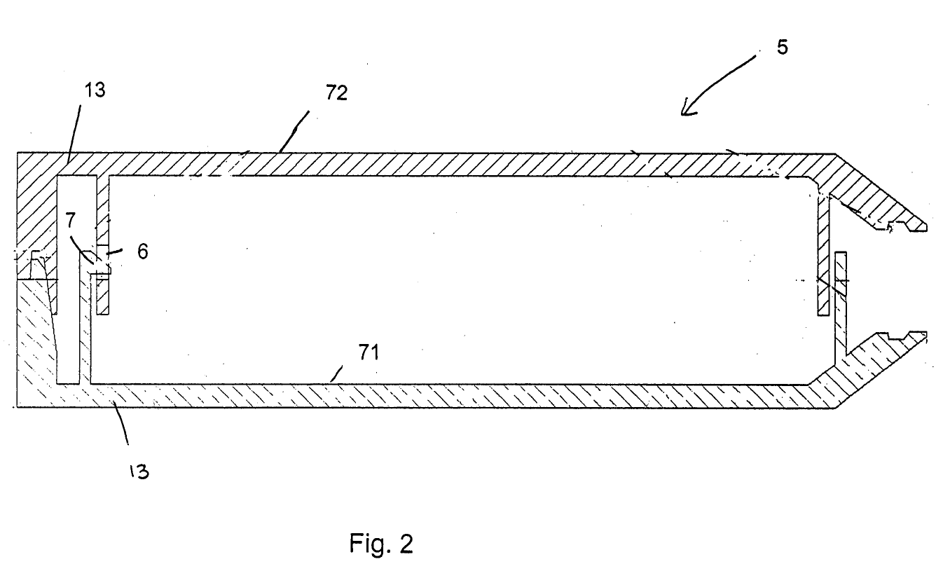

As shown in FIGS. 1 and 2, a door 5 formed by gas assisted thermoplastic injection (GATI) molding and the method of forming a door 5 by GATI molding is shown and described.

GATI molding can be used to make, among other articles, door skins, skins for muntin doors, and door frames. A muntin door can hold between its two skins a sheet 11 material. The sheet 11 may be of a variety of materials including glass, plastic, paper, or combinations thereof. The sheet 11 may also be opaque or transparent, or combinations thereof. FIG. 1 shows a muntin or grille door 5. The muntin or grilles are bars or strips that divide the door into lites. A lite is a section framed by the muntin and can expose the sheet material. The muntins may provide for 5 lites, 10 lites, 15 lites or any other number of lites through which the sheet material 11 may be viewed. In one embodiment, as shown in FIGS. 1 and 2, a door 5 is shown having a sheet 11 of material inserted between a first skin 13 and a second skin 13 of the door 5. Of course, although the two skins of a muntin door 5 may hold a sheet 11 there between, they do not have to.

The two skins 13 of the door 5 can be held together by a number of conventional mechanisms including but not limited to glues and screws. Alternatively, the door 5 can be held together by a snap fit mechanism as described in U.S. Serial No. 60/331,926 incorporated herein by reference in its entirety. Door skins 13 have an interior surface 71 and an exterior surface 72. When two doors skins 13 are brought together to make an assembled door 5, the interior surface 71 of the two door skins 13 face one another. Between the two interior surfaces 71 of the door skins 13 can be sandwiched any type of foam or insulation material. The exterior surface 72 of the door skins 13 is generally the opposite side of the skin exterior surface 13 from the interior surface 71. The exterior surface 72 is generally what is seen by the user and most directly exposed to the elements. As shown in FIG. 2, the interior surface door skins 13 are made having grooves 6 and projections 7 arranged on the interior surface 71 of each door skin 13. The door skins 13 allow for the complementary association of the projections 7 into the grooves 6, thereby holding the two door skins 13 together to form an assembled door 5. The two door skins 13 with grooves 6 and projections 7 which are then “snap-fit” into an assembled door 5 are identical. In order for the grooves 6 and the projections 7 to be complementary, one of the door skins 13 is rotated 180° so that its grooves 6 and projections 7 can be associated with the grooves 6 and projections 7 on the complimentary door skin 13. The assembled door 5 can be left hollow or filled with foamed material.

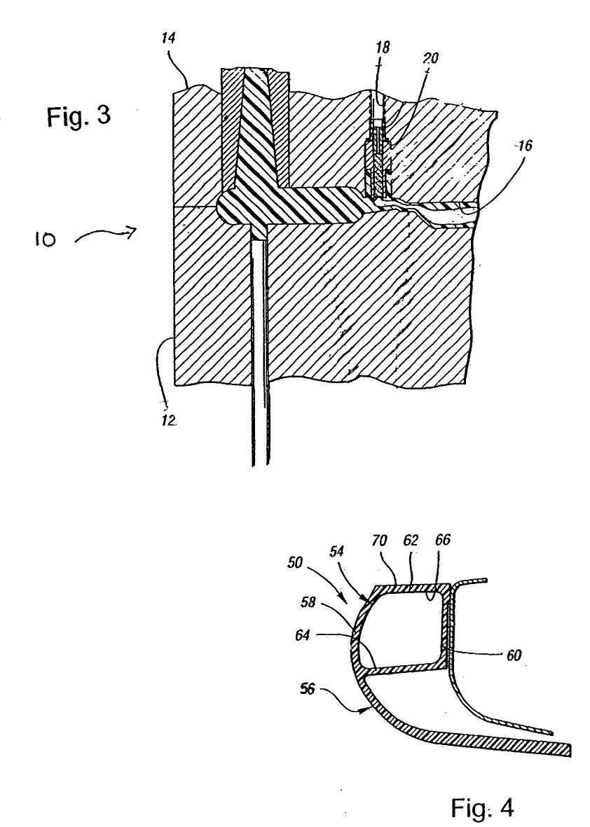

FIG. 3 shows a mold 10 for use in a GATI molding system. The mold 10 includes a first mold half 12 and a second mold half 14. The first and second mold halves 12 and 14, respectively, are movable relative to each other between an open position and a closed position, wherein the first and second mold halves 12 and 14 respectively define an article-defining cavity 16.

As further discussed below, the gas can be injected into the mold 10 in a variety of manners including injecting the gas through a nozzle, or through gas pins located at one or more critical areas of the mold 10. In one aspect, the second mold half 14 includes a gas passageway or channel 18 which extends from an exterior mold surface (not shown) of the second mold half 14 to an inner interior mold surface 20 of the second mold half 14 in fluid communication with the article-defining cavity 16.

Referring now to FIG. 4, there is illustrated a sectional view of a plastic article 50, such as a door frame. The door frame includes a hollow body section 54, and a solid wall section 56, which is connected to and extends downwardly and rearward from the hollow body section 54. The hollow body section 54 includes a front wall 58, a rear wall 60, an interconnecting top wall 62 and bottom wall 64. The hollow body section 54 is formed by the pressurized fluid to define a closed interior surface extends at least partially through the hollow body section 54 to provide a gas channel 66 within the hollow body section 54. The top wall 62 of the hollow body section 54 defines a sink-free exterior surface 70 of the door 5.

In one embodiment, the type of thermoplastic resin used in making a GATI molded door 5 is, but not limited to, PCASA. Further, “heat deflective plastic” or HDP may be used to make a GATI molded door 5. A high HDP plastic will warp only at high temperatures. Temperature at which a door will warp is important depending on the climate in which the door will be used, such as in hot temperatures. The temperature of the environment it is used in aids in determining the grade of HDP plastic for the GATI molded door 5.

The GATI molded door skins 13 have an interior surface 71 and an exterior surface 72. The exterior surface 72 can be smooth or have, for example, a wood grain design. The interior surface 71 may have a series of ribs, undercuts and/or bosses (not shown). Ribs on the interior surface 71 of the skins 13 impart strength and are added to strengthen a particular point of the door 5. Ribs are arranged on the interior surface 71 of the skins 13 based on a determination of where they would add structural support and the weight and shearing factors to which the door 5 will be subjected. Based on these variables (and perhaps others), the placement of the ribs is determined. For example, the location of the ribs may not be as important as the amount of weight the door 5 is to be able to sustain. For example, if a plastic door is hinged on one side during use and is to hold within the two skins 13 a sheet 11, the shearing force exerted on the door 5 may be from 60 to 70 kilograms. The number and location of the ribs would be determined keeping in mind the desirability of constructing a door 5 which can safely withstand forces of 60 to 70 kilograms. GATI molding also prevents or eliminates sink marks opposite the rib on the exterior surface 77 of the skin door 13.

The thermoplastic resin used in the article making process, such as but not limited to a door 5, can be pre-colored. Alternatively, GATI molded articles can be made with uncolored resin and left unpainted or painted for ease of maintenance after molding.

One feature of a GATI molded door 5 is that it can be made in a much shorter time than a wood door. For example, one skin 13 of a GATI molded door 5 can be made in a minute cycle. A GATI molded door 5 is made much quicker than a thermoset door. To make a thermoset door, two sheets of thermoset plastic are used. Separately, each thermoset plastic sheet is laid in a mold and heated. Each skin of the door is pressed from the heated sheet in 5 to 6 minutes or two skins for an assembled door is pressed in about 10 to 12 minutes. There are many design limitations with thermoset. Undercuttings are very difficult with thermoset because thermoset molds are highly unsophisticated. Furthermore, undercuts are the grooves 6 into which prongs 7 would be introduced when door skins 13 are snapped together. Additionally, it is difficult to regrind and reuse thermoset plastic. Whereas, an assembled GATI molded door 5 can be made in less than two minutes.

In another embodiment, a method of making a GATI molded door 5 using GATI molding is shown and described. GATI molding is the introduction of pressurized fluid into an injection molded part during the packing phase of the molding cycle. The pressurized fluid is typically, but not limited to, nitrogen gas which is introduced into the mold cavity at or near the completion of the plastic injection. The pressurized fluid serves several purposes. It allows the formed article to have hollow interior portions which correspond to weight and material savings. The pressurized fluid within the mold cavity applies outward pressure to force the plastic against the mold surfaces while the article solidifies. The cycle time is reduced as the gas migrates through the most fluent inner volume of the plastic and replaces the plastic in these areas which would otherwise require an extended cooling cycle. The gas pressure pushes the plastic against the mold surfaces, thereby obtaining the maximum coolant effect from the mold.

The injection of nitrogen gas into the mold can be accomplished using several methods. Gas can be injected into the mold either through the molding machine's nozzle, or any apparatus which produces a jet of fluid, or through gas pins located at one or more critical areas of the part. Introducing the gas through the nozzle allows the process to be utilized on existing tooling without altering the tool. Introducing the gas into the part gives the designer more flexibility by allowing the gas to be introduced into the area most needed of the part. It also can allow for more than one gas injection point.

The GATI molding process is able to mold thick walls without surface imperfections. Additional advantages are also the dramatic decrease in cycle times due to the resulting thinner wall sections and the material being forced into constant contact with the mold walls. The parts can be molded with lower pressure because the part is not being completely filled or packed with plastic and the gas nozzle is much closer to the end of fill, therefore the pressure needed is lower. This enables larger parts to be made on smaller machines. The minimum clamp tonnage required for conventional molding is 2-5 ton/in². Using the GATI molding process, required clamp tonnage is sometimes as low as 0.5 ton/in². The lower injection pressure also results in a part with much lower internal stress. This will enable parts to be molded with less warp.

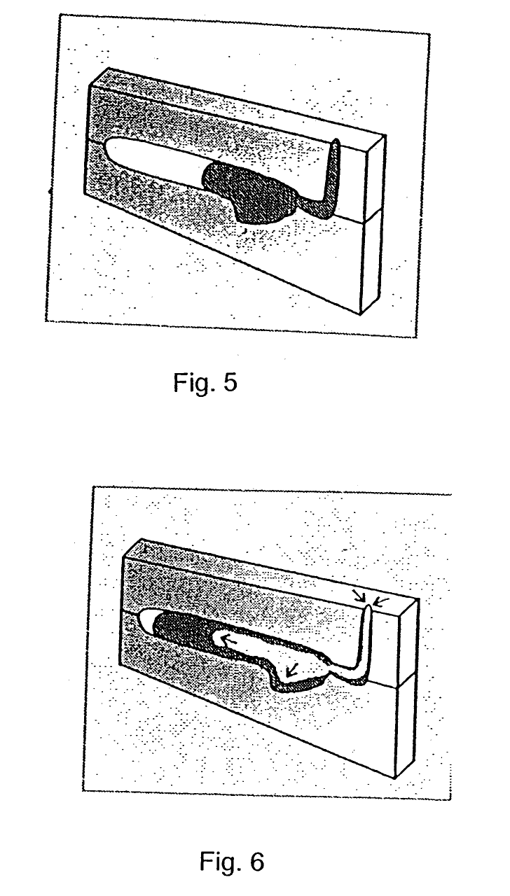

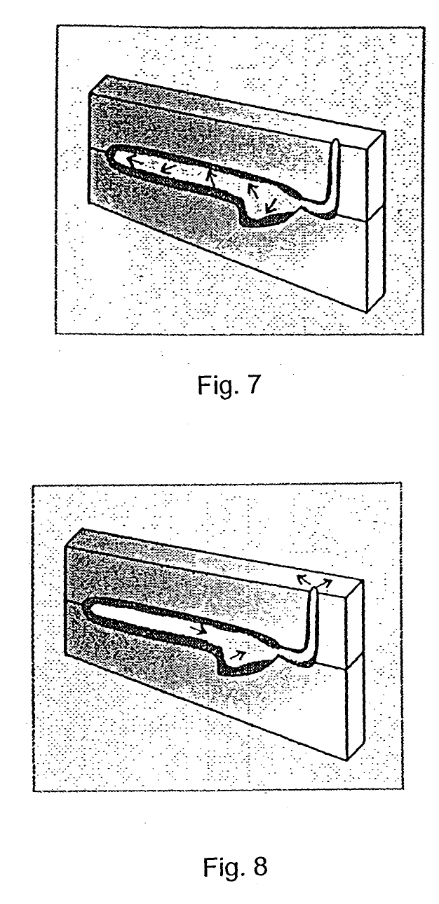

As shown in FIGS. 5-8, the basic GATI molding process includes injecting a resin into a mold 10. Thermoplastic resins melt through a shearing process. The mold 10 is generally a two piece mold so that once the resin has solidified in the mold 10, the two mold pieces can be separated and the molded article punched out of the mold. As shown in FIG. 6, after the resin, shown in solid, is injected into the mold 10, gas, shown by the arrows, is injected into the mold 10. As shown in FIG. 7, once the gas is injected into the mold 10, the gas is held in the mold 10 pressing the resin against the mold walls. As shown in FIG. 8, once the gas has formed a cavity in the resin and the resin has begun to solidify, the gas is vented from the interior of the mold 10. As the part is cooling, the voids that form in the center of thick walls or at the intersection of ribs and bosses will be packed by the inert gas. The gas will push the material to the surface of the mold and keep these areas from sinking and yield a good surface appearance. Once the molded article has obtained a minimum level of solidity, the molded article can be punched out of the mold 10. The resin or plastic used in gas injection molding can include, but is not limited to, polypropylene, polyvinyl chloride, and ABS and combinations thereof. GATI molding can be applied to virtually all thermoplastic materials, with or without fillers.

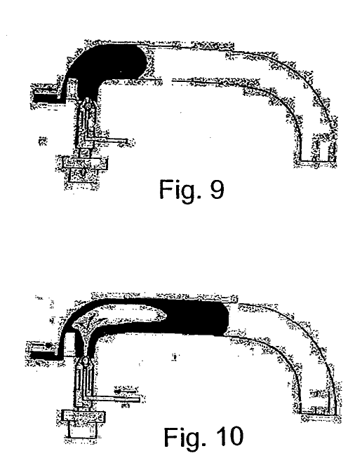

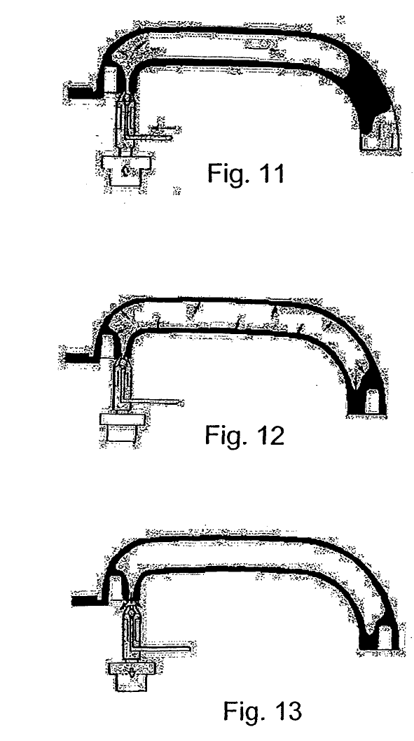

In one embodiment of a method of making a door 5 having two skins 13 by GATI molding, as shown in FIG. 9, the resin is injected into an empty door mold cavity. The resin enters the mold cavity through an edge gate. As shown in FIG. 9, gas injection begins as the resin injection continues thus preventing a hesitation of the flow front. In one aspect, the gas is injected through a gas pin. As shown in FIG. 11, the resin shot is completely injected into the mold as gas injection continues. This gas injection keeps the flow front moving as the bubble forms inside the article thus stretching the skin to the end of the mold 10. As shown in FIG. 12, the resin material has completely filled the door mold, the skins are fully established, and the gas bubble continues to be pressurized thus creating an internal cushion to compensate for resin shrinkage. As shown in FIG. 13, the door 5 has cooled adequately to establish skin strength so the gas pressure can be vented. The gas must be vented prior to mold opening to avoid explosion. The gas pin retracts to accomplish this venting action.

In another embodiment, in addition to making the door 5 through a GATI molding process, doors 5 can be made using a water assisted injection molding process. The water assisted injection molding process is similar to a gas assisted injection molding, except water is sent through the mold rather than gas. Also, an exit opening for the water is required in the mold and the resulting molded door 5. There is no need for an opening in a GATI molded door 5 because the gas can remain in the mold.

If water assisted injection molding is used in a high temperature environment, or in a manufacturing plant with high humidity and heat, the steel of the mold will begin to sweat. This will cause water to collect in the mold and may cause many rejected skins 13. As soon as a mold starts sweating, unfilled parts or incomplete joints can be created in the molded article, such as a door 5.

Another possible process that can be used to make a door 5 is using a micromicelle or foam. Foam is injected into the mold after the melted plastic is injected into the mold. The foam exerts a pressure on the melted plastic, pushing the plastic into the mold and better fills the molded part.

In making the door 5 using GATI molding, the gas can be injected through the same nozzles as the plastic is injected or through different nozzles not used for plastic injection. To make a door 5, it is advantageous that gas be injected into the mold thru specifically placed nozzles. For example, sending gas through a main nozzle does not provide the same degree of control of the gas and plastic as sending the gas through specifically located nozzles. Where to locate the nozzles to introduce the gas can be based on a modeling or simulated making of the part. In making a door 5 from about 6 to about 8 gas injection points may be required. The number and location would be based on the door 5 being made. The gas injection nozzles will be located at various points based on the door 5, for example, a very narrow door 5 versus a wide door 5. The bigger the door 5, generally the more gas nozzles at more locations. Injection of the gas thru the nozzles could leave in the resulting molded door 5 gas channels showing the path the gas had taken in the door 5 while it was being molded.

The introduction of the gas is a time sensitive event. It is sequentially based on the introduction of the plastic into the mold 10. Gas is generally not injected until the plastic fills the mold 10 Generally, the plastic fills 90% of the mold 10 before the gas is injected.

Depending on the design of the mold 10 and, ultimately, the door 5, gas may be injected in both inside and outside gas nozzles. In a preferred embodiment, gas is injected in both inside and outside gas nozzles.

In non GATI molding, the thinner the wall, the more difficult it is to make. Non-GATI molding is limited to making a 3 or 4 millimeter thick wall. GATI molded doors 5 do not have this limitation. GATI molding can make an approximately 1.2 to 2.2 millimeter thick skin door.

The discussion above is descriptive, illustrative and exemplary and is not to be taken as limiting the scope defined by any appended claims.

1. A single piece, hollow plastic door formed by the following process comprising:
forming from a molten plastic resin by a gas-assisted injection molding system including a mold having an article-defining cavity and an injection aperture wherein molten plastic resin is injected through the injection aperture and wherein pressurized fluid is communicated to the molten plastic resin in the door-defining cavity to at least partially distribute the molten plastic resin, wherein the door is concave in shape so as to press against a panel held between two halves of the door frame.

2. A method of making a molded plastic article comprising:
providing a mold;
injecting into the mold a thermoplastic resin;
injecting into the mold a fluid under pressure capable of forming a fluid channel in the injected thermoplastic resin;
holding the fluid in the mold, the fluid pressing the thermoplastic resin against the mold;
allowing the thermoplastic resin to solidify in the mold;
venting the fluid; and
removing the article from the mold.

3. The method of claim 2 wherein the mold is a two part mold.

4. The method of claim 2 further comprising a plurality of nozzles capable of introducing the fluid or resin into the mold associated with the mold.

5. The method of claim 2 wherein the thermoplastic resin is selected from at least one of the group consisting of polypropylene, polyvinyl chloride, heat deflective plastic, PCASA, and ABS.

6. The method of claim 2 wherein the fluid is selected from the group consisting of nitrogen gas, micromicelle, foam, and water.

7. The method of claim 2 wherein the article is selected from the group consisting of a door, a door frame, and a door with muntins.

8. The method of claim 2 wherein the resin is colored.

9. The method of claim 2 further comprising injecting the fluid using a nozzle.

10. The method of claim 2 further comprising injecting the fluid using a gas pin.

11. The method of claim 2 further comprising injecting the thermoplastic resin using a nozzle.

12. A door made by the method of claim 2.

13. The door of claim 12 further comprising
a first skin and a second skin, the first skin and the second skin capable of association to form an assembled door.

14. The door of claim 13 further comprising:
a plurality of muntins forming a plurality of lites in the door; and
a sheet of material held between the first skin and the second skin,
wherein the sheet of material is visible through the lites in the assembled door.

15. The door of claim 12 having an exterior surface.

16. The door of claim 15 wherein the exterior surface is smooth.

17. The door of claim 15 wherein the exterior surface is patterned.

18. The door of claim 15 wherein the exterior surface is sink free.

19. The door of claim 12 having an interior surface.

20. The door of claim 19 further comprising a rib projecting from the interior surface.

21. The door of claim 13 wherein the first skin and the second skin are capable of snap-fit association.

22. The door of claim 13 further comprising an insulating material sandwiched between the first skin and the second skin.
